(19) United States
(12) Patent Application Publication
(10) Pub. No.: US 2011/0239656 A1
(43) Pub. Date: Oct. 6, 2011

(54) Water Augmentation System

(76) Inventor: Matthew Crume, Longview, WA (US)

(21) Appl. No.: 12/753,107

(22) Filed: Apr. 2, 2010

(51) Int. Cl. F02C 3/30; F02C 7/00

(52) U.S. Cl. 60/775; 60/39.53

(57) ABSTRACT

An improved method of augmenting a marine-based turbine engine with water by using a single or a plurality of valves to control the intake and/or the distribution of the water to specific areas of the turbine. The system most commonly incorporates a variable water intake which can be closed or partially closed at higher vessel speeds where the advantages of the system begin to outweigh the benefits. In certain embodiments, a water tank is also used, which can store water for use when the intake system is suspended above the water surface due to wave variations. The improved water augmentation system is beneficial or not detrimental at all speed ranges of the marine vessel, utilizes a low profile water scoop while providing constant water injection, allows for the augmentation of the high temperature exhaust at slower speeds which can be beneficial for initial acceleration, minimizes or eliminates the drag of the injection system on the gaseous flow, offers control over the amount of augmentation, and offers a greater amount of water augmentation than previously known.

### BACKGROUND

1. Field of Invention

This invention relates to marine propulsion systems, specifically to an improved water-augmented gas turbine.

2. Description of Prior Art

Demand for marine vessels with high cruise speeds drove the development of unique ship designs such as hydrofoils and hovercrafts. This demand also drove the development for a propulsion system that would be lighter, more efficient, and more reliable than current impellor-based water jets and supercavitating propellers. Many attempts were made using a gas turbine or jet engine that utilized the nearby water to create a two-phase flow. Such a design has the potential to be very lightweight, reliable, and efficient. Adding water or another liquid to the exhaust of a gas turbine or jet engine slows down the velocity and increases the density of the exhaust mix. This increases the propulsive efficiency of the engine at vessel speeds where otherwise un-augmented jet exhaust velocities would be many times faster than the ship velocity.

U.S. Pat. No. 3,137,997 to Kaminstein (1964) utilizes this principal to dramatically increase the thrust of a pulsejet type engine. The water accelerator portion of his invention has an open duct to collect ram water, a mixing area where exhaust from the pulsejet accelerates the water, and an exhaust nozzle located above the surface of the water for expelling the two-phase flow. The water accelerator has 3 breather tubes which supplies the pulsejet combustion chamber with fresh air after each burning cycle. These breather tubes increase the complexity of the water accelerator and limit the accelerator's adaptability for use with other, more reliable, jet designs.

A further attempt was made to employ a two-phase flow in U.S. Pat. No. 3,265,027 to Brown (1966). This design forced pressurized exhaust gas in the form of bubbles into a contained flow of water. As the flow entered an exhaust nozzle the bubbles would expand, thereby increasing the volume of the mixture. This increase in volume resulted in an increase in exhaust exit velocity which produced thrust. While the design was more versatile than Kaminstein's, it suffered commercially because the air injectors created tremendous back-pressure for the engine producing the gasses. U.S. Pat. Nos. 3,643,438 to Barsby (1972), and 5,598,700 to Varshay (1997) are similar.

Another design emerged which was more versatile than Kaminstein's and more suitable for high speed operation than Brown's. Water was collected with a scoop, and under ram pressure, injected into the exhaust of an aircraft style turbofan or turbojet engine. This design became known as the “mist jet.” It effectively used water to increase the density of the exhaust while decreasing the velocity to make the engine more efficient at speeds common to marine vessels. It was discovered that the water augmentation was most effective when only added to the cool bypass air of a turbofan. This avoided the energy losses associated with the cooling of the exhaust caused by the water. Information on this type of propulser can be found in the following papers: A Water-Augmented Air Jet for the Propulsion of High-Speed Marine Vehicles—R. Meunch and A. Ford, Naval Ship and Research and Development Laboratory of Annapolis Md., A.I.A.A. Paper 69-405; A Preliminary Parametric Study of a Water-Augmented Air-Jet for High-Speed Ship Propulsion—R. Meunch and T Keith, U.S. Navy Marine Engineering Laboratory of Annapolis Md., R&D Report 358/66; and Water-Augmented Turbofan Engine—W. Davison and T. Sadowski, United Aircraft Research Laboratories of East Hartford Conn., A.I.A.A. Paper 67-362.

The mist jet was a promising engine design due to its simplicity, reliability, low cost, and low weight characteristics. However, it never entered commercial service for multiple reasons. The water injectors in the fan duct created significant drag. Also the water flow would be either intermittent or the water scoop would have to be placed well below the hull of the vessel to allow for wave variations. This caused a significant amount of drag, especially at the high speeds for which the mist jet was best suited. Furthermore, because only the bypass air was augmented, the amount of water that could be injected in the system was limited, reducing the available thrust at slower speeds. And lastly, no consideration was made for the removal of the augmentation system at such high speeds where the drag of the water scoop outweighs the benefit of the more efficient two phase exhaust mixture.

### OBJECTS AND ADVANTAGES OF THE INVENTION

Therefore, it is the purpose of this invention to provide high speed marine vessels an efficient, reliable, low weight, and simple propulser; specifically, a gas-turbine, water-augmentation system that:
is beneficial or not detrimental at all speed ranges of the marine vessel
utilizes a low profile water scoop while providing constant water injection
allows for the augmentation of the high temperature exhaust at slower speeds which can be beneficial for initial acceleration
minimizes or eliminates the drag of the injection system on the gaseous flow
offers control over the amount of water augmentation
offers a greater amount of water augmentation than previously known

Further objects and advantages of the present invention will become apparent after a consideration of the ensuing description and drawings.

### SUMMARY OF INVENTION

The improved water augmentation system consists of a valve arrangement that regulates the water intake and the distribution to the engine. Some embodiments of the system allow for water distribution to different areas of the engine, and certain designs may incorporate a holding tank and a water pump.

### DRAWING FIGURES

FIG. 1 shows a side cut away view of an augmentation system with a variable water intake, a holding tank, a water pump, and variable water injectors.

FIG. 2 shows a side cut away view of portion of an augmentation system comprised of a water pump, a holding tank, and a variable water intake which is directly attached to the holding tank and fitted with a flap valve.

FIG. 3 shows a side cut away view of a portion of an augmentation system comprised of a water pump, a holding tank, and two variable water intakes; one being attached directly to the holding tank.

FIG. 4 shows an isometric view of one embodiment of a variable water intake with a portion of the water ducting and hull not shown.

FIG. 5 shows an isometric view of one embodiment of a variable water intake with a portion of the hull not shown.

FIG. 6 shows a view of an augmented turbine with variable water injectors comprised of sides A and B as defined by line 1-1. Side A shows an isometric view of the turbine with the outermost cowling not shown, and side B shows an isometric cut away view of the turbine where the top half of the engine is not shown.

FIG. 7A shows a side cut away view of an augmentation system where a turbine is raised up a strut, but the exhaust gas is ducted down into the hull near the water level. A secondary valve is incorporated in the water ducting, as well as a water pump. FIGS. 7A and 7B depict two different positions of the secondary valve.

FIG. 8 shows an isometric view of a high speed marine vessel equipped with an improved water augmentation system.

FIG. 9 shows a side cut away view of an augmentation system with a variable water intake, variable water injectors, and a holding tank which is simply a large diameter duct that is situated above the turbine.

FIG. 10 shows a side cut away view of an augmentation system with a variable water intake, a holding tank, variable water injectors, and a water pump to lift the water to a turbine situated well above the surface of the sea.

FIG. 11 shows a side cut away view of an augmentation system equipped with only a variable water intake and variable water injectors.

FIG. 12 shows a side cut away view of an augmentation system that is equipped with a variable water intake and variable water injectors. This system only augments the bypass air of the turbine.

FIG. 13 shows a side cut away view of an augmentation system with a variable water intake, a holding tank, a water pump, and variable water injectors. The intake, holding tank, and pump are positioned so that the flow of water will flow directly to the turbine with minimum changes in direction.

Reference Numerals

| | |
|---|---|
| 20 | Variable Water Intake |
| 21 | Intake Hinge |
| 22 | Intake Water Scoop |
| 23 | Intake Hydraulic Cylinder |
| 24 | Intake Hydraulic Control Rod |
| 25 | Hydraulic Control Mount |
| 26 | Hydraulic Control Bracing |
| 27 | Intake Shut-Off Panel |
| 28 | Intake Flap Valve |
| 29 | Intake Flap Valve Hinge |
| 30 | Water Ducting |
| 31 | Water Tank |
| 32 | Water Pump |
| 33 | Secondary Water Valve |
| 34 | Cylinder Bolt |
| 40 | HARTH (High Aspect Ratio Twin Hull) |
| | Vessel Equipped with an Improved Water |
| | Augmentation System |
| 41 | Vessel Hull |
| 42 | Vessel Strut |
| 43 | Vessel Passenger or Cargo Compartment |
| 50 | Water-Augmented Turbo-Fan Jet Engine |
| 51 | Gate Valves |
| 52 | Jet Bypass Fan |
| 53 | Jet Compressor |
| 54 | Jet Fuel Inlet |
| 55 | Jet Combustion Chamber |
| 56 | Jet Turbine |
| 57 | Jet Exhaust Nozzle |
| 58 | Butterfly Valve |
| 59 | Jet Bypass Exhaust Nozzle |
| 60 | Extended Jet Bypass Duct |

### DETAILED DESCRIPTION OF INVENTION

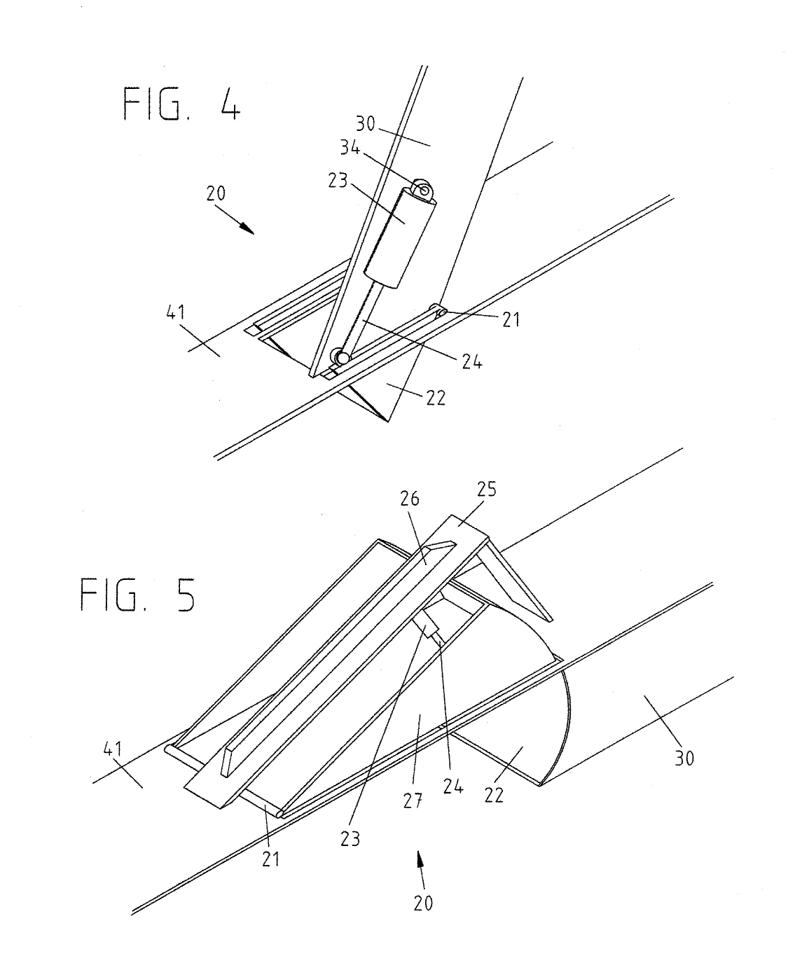

FIGS. 4 and 5 detail two embodiments of a variable water intake 20; an integral part of the overall system described below. In FIG. 4, an intake water scoop 22 is attached to a vessel hull 41 by an intake hinge 21. A water ducting 30 is attached to the hull by a weld and surrounds the water intake. Half of the water ducting 30 is not shown FIG. 4 for clarity. An intake hydraulic cylinder 23 is bolted to the water ducting in such a way that the cylinder is able to rotate about the bolt 34. The cylinder 23 uses hydraulic pressure to move an intake hydraulic control rod 24, which pushes or pulls the intake water scoop 22 open or closed. This design allows the water scoop 22 to be completely removed from the water.

FIG. 5 details a different embodiment of the water intake system 20. In this embodiment, the intake scoop 22 is fixed to the bottom of the hull 41. The intake flow is controlled by an intake shutoff panel 27, which is attached to the hull 41 by the intake hinge 21. A hydraulic control mount 25 is welded to the hull and reinforced by a hydraulic control bracing bar 26. The hydraulic control cylinder 23 is bolted to the control mount 25 in such a way that it can pivot parallel with the longitudinal axis of the craft. The hydraulic control rod 24 that leaves the cylinder 23 is attached to the shut off panel 27 in such a way that it can also pivot as it moves the panel up and down. When the panel 27 is down it provides a streamlined covering for the intake scoop 22, lowering the form drag and the induced drag acting against the vessel as it moves through the water.

The intake system 20 is an integral part of the invention and either of the discussed embodiments, or many others as defined by the claims which follow this specification, can be used in the various forms of the invention which are discussed below.

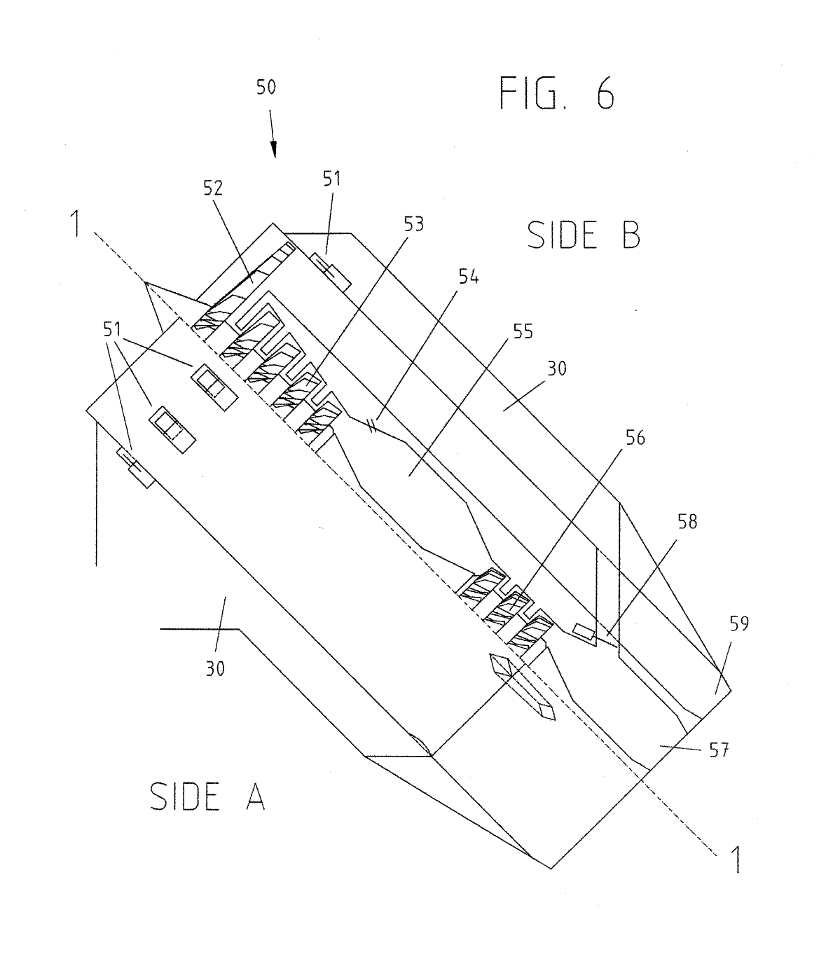

One embodiment of the improved water augmentation system is shown by FIG. 1, a cut away side view of the invention. From the water intake system 20, the water ducting 30 which leaves the intake 20 is welded to a holding tank 31 at its highest point. A water pump 32 is attached to a low position on the holding tank 31. Additional water ducting 30 leaves the water pump 32 and surrounds a water-augmented turbo-fan jet engine 50. The injection system is shown in detail by FIG. 6.

Side A of FIG. 6 shows an isometric view of the turbine 50 with the outermost cowling not shown, and side B shows an isometric cut away view of the turbine 50 where the top half of the engine is not shown. As depicted by side A, multiple gate valves 51 open a passageway from the ducting 30 to the engine 50. The gate valves 51 can be controlled hydraulically or electrically. Side B shows that the opening allows water to flow into the area just rear of a jet bypass fan 52. No injectors are utilized in this embodiment.

The second half of the injection system is also shown in FIG. 6. Near the rear of the engine 50 water is ducted directly into the exhaust portion of the jet aft of a jet turbine 56 and before a jet exhaust nozzle 57. The flow of water is controlled by a butterfly valve 58. This butterfly valve 58 can also be controlled hydraulically or electrically. Multiple passageways and butterfly valves can be incorporated to distribute the water into the exhaust area of the jet.

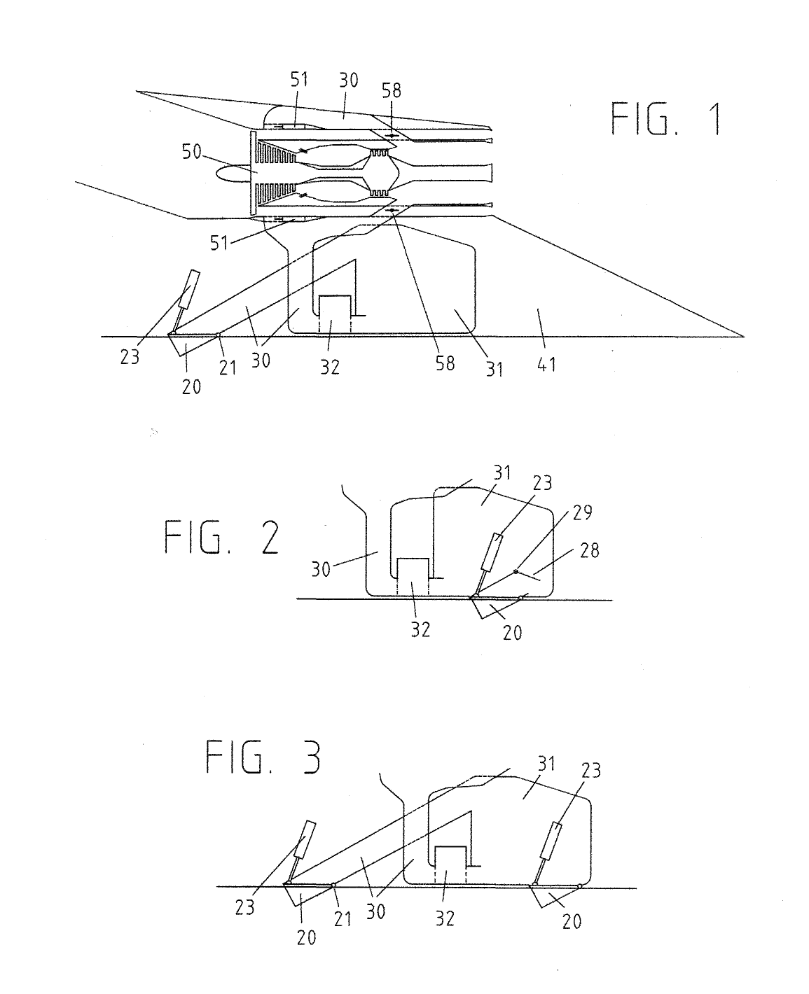

Multiple embodiments of this invention can be designed to accomplish its objects within the scope of the claims which follow. For example, FIG. 2 depicts a system where the variable intake system 20 is attached directly to the holding tank 31. A flapper valve 28 is added to the intake system by a hinge 29.

Furthermore, FIG. 3 depicts a system with dual intake valves 20. One is ducted to the highest point of the holding tank 31 as in FIG. 1, and the other intake valve 20 is attached directly to the holding tank 31 as in FIG. 2. Both valves are controlled hydraulically, and neither incorporates a flapper valve.

FIG. 9 shows a system where the water pump 32 is removed and gravity alone feeds the augmentation system. The turbine 50 is mounted on a vessel strut 42. Also mounted in the strut 42 is the holding tank 31, located above the turbine 50 but below a vessel passenger or cargo compartment 43. The holding tank 31 in this embodiment is simply a pipe of large enough diameter to hold enough water to feed the engine 50 while the water intake 20 is out of the water due to wave variations. The water ducting 30 is elongated from the intake system 20 to the holding tank 31 due to the holding tank's raised position.

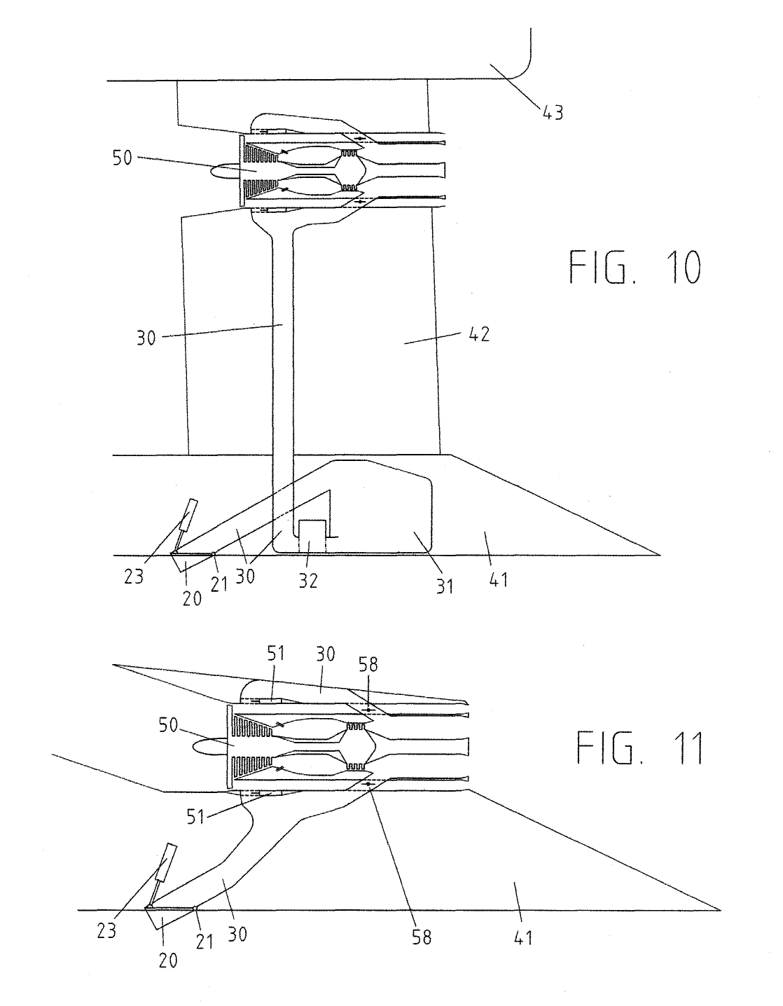

FIG. 10 displays an embodiment of a system where the turbine 50 is raised significantly up a vessel strut 42. The water ducting 30 is of course elongated from the water pump 30 to the turbine 50.

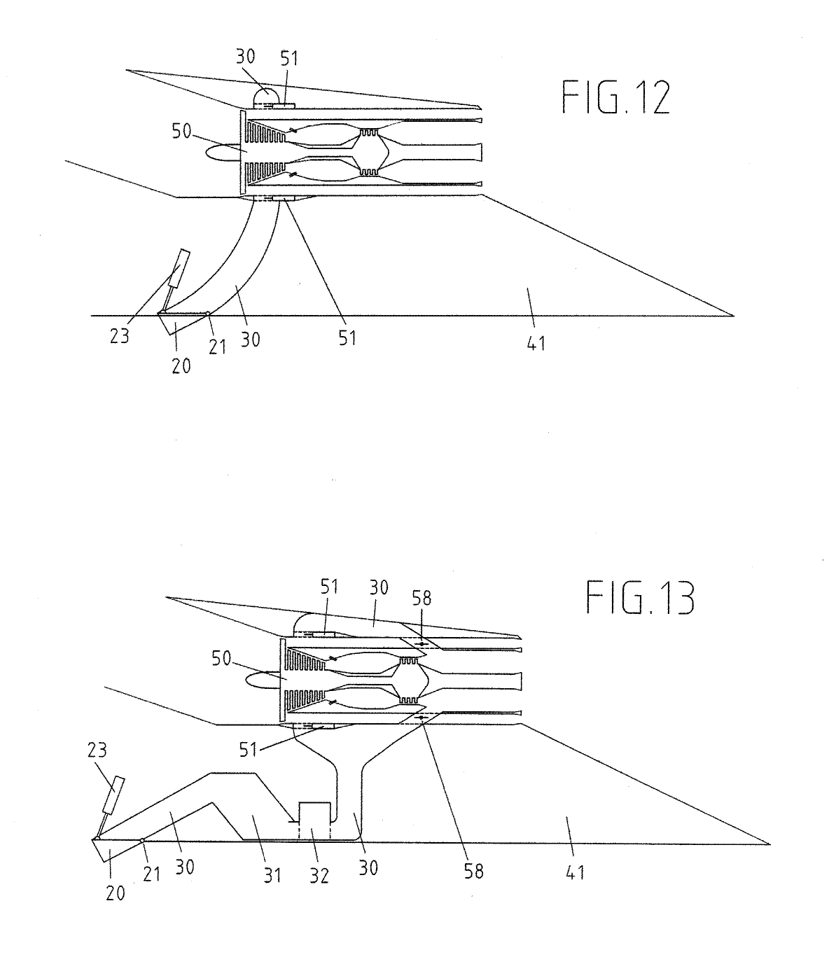

FIG. 11 and FIG. 12 shows that the holding tank 31 and the water pump 32 can be removed from the system. FIG. 12 shows that even the rearmost ducting surrounding the turbine 50 can also be excluded. Only the bypass is air is augmented in this design, which can be beneficial under certain circumstances. The water intake 20 remains variable in both of these embodiments.

FIG. 13 depicts the system where the intake 20, holding tank 31, pump 32, and ducting 30 to the turbine 50 are all in a streamlined position. This arrangement has certain advantages and disadvantages; both are discussed below.

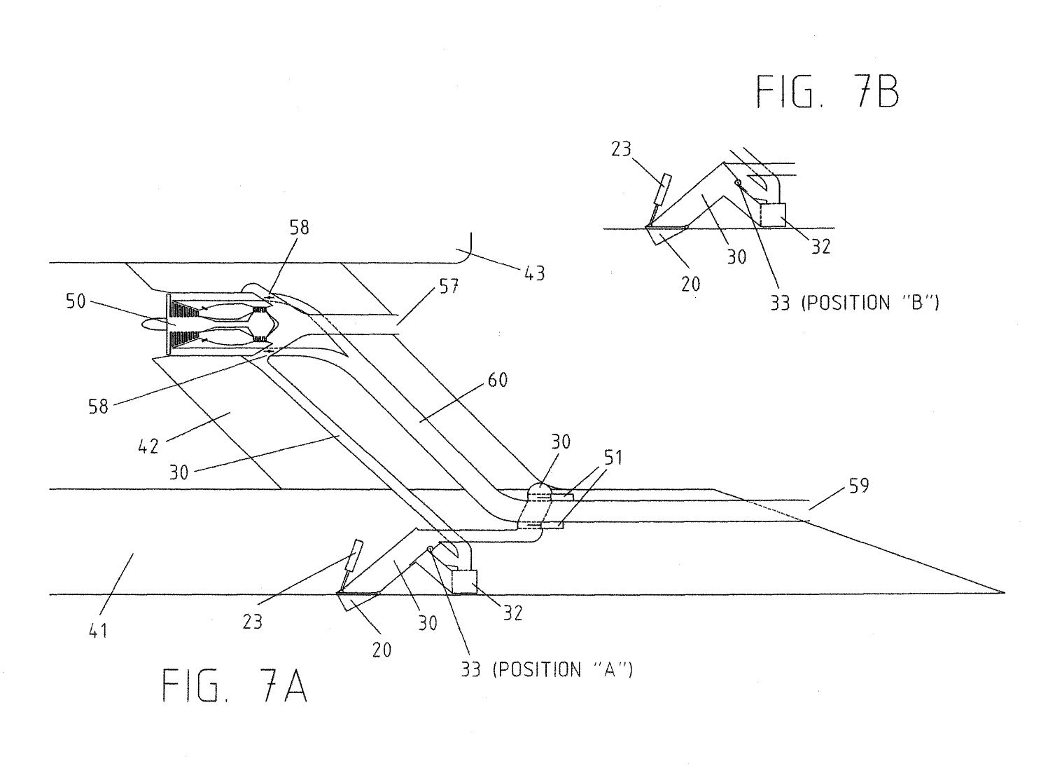

And lastly, FIGS. 7A and 7B depicts a system that incorporates an extended jet bypass duct 60. This extended ducting leaves the turbofan 50 which is located near the top of a vessel strut 42 and directs the bypass air towards the water line. The jet exhaust still exits the turbofan 50 in the normal fashion; out the jet exhaust nozzle 57. Just above the water level the extended jet bypass duct 60 curves to run parallel with the water. The duct 60 then incorporates an exit nozzle 59 at the end of the vessel hull 41. The water ducting and injection systems are also unique in this embodiment. Shortly aft of the intake system 20 is a secondary intake valve 33. In position “A” (FIG. 7A) the valve 33 directs the water to the gate valves 51 located at the bend of the bypass ducting 60 to augment the bypass air. In position “B” (FIG. 7B) the valve 33 directs the water to the water pump 32. The water pump 32 then pressurizes the water and forces it to both the gate valves 51 to augment the bypass air, and the butterfly valves 58 at the turbofan engine 50 to augment the jet exhaust. The many advantages of such an embodiment are described below.

### Operation of Invention

### Embodiment Portrayed by FIG. 1

Water is forced into the intake system 20 by ram pressure, or the forward movement of the vessel. The intake system 20 is variable, meaning that it can be partially or completely removed from the water flow. This design allows the drag created by the intake to be removed at higher speeds. Drag increases by the square of the velocity of the craft; meaning if the velocity doubles, the drag quadruples. The benefit of the augmentation also decreases with speed. The augmentation slows the exhaust gasses to reasonable speeds that make the jet more efficient, but at high vessel speeds this is not needed. Therefore, as the speed of the craft increases, drag is dramatically increasing and the thrust benefit is decreasing. There is a point where the system becomes detrimental; which is why the variable intake 20 is vital. While augmentation has the potential to double the thrust produced at certain speeds, the systems' drag must be removable if extremely high speed operation is expected. Furthermore, as the vessel speed increases the amount of water being forced into the intake system will also increase. Having a variable intake allows the amount of intake water to be controlled and keeps the system from flooding the engine or creating unnecessary drag.

From the variable intake system 20, water flows up the water ducting 30 into the holding tank 31. The holding tank 31 is made large enough to hold a sufficient amount of water to provide a constant supply to the water pump 32, even when the intake system 20 is suspended in air due to wave variations. This allows the intake system 20 to not be placed so far below the hull 41 that it generates extra drag.

From the holding tank 31, a pump 32 forces the water into the ducting 30 that surrounds the jet 50. Multiple gate valves 51 allow the water to enter the bypass area of the jet, while several butterfly valves 58 allow the water to flow into the exhaust portion of the jet. (See FIG. 6.) All valves are controllable; allowing the perfect amount of augmentation to different parts of the engine at different speeds. A computer can be programmed to open and close the valves to varying degrees based on the speed of the vessel. This will allow the system to be as efficient as possible. For example, during initial acceleration the butterfly valves 58 controlling the augmentation to the exhaust portion of the jet 50 will be full open, but they can close at higher speeds. In theory, at higher speeds the energy losses associated with cooling the jet exhaust outweigh the benefit of augmentation. But, at low speeds augmenting the exhaust is beneficial; the improved water augmentation system takes advantage of this benefit which was previously unattainable.

Injectors are not incorporated in this embodiment. While not prohibited by the affixed claims, personal and outside research has indicated that eliminating injectors has the following benefits:
The flow of water is not restricted. This reduces strain on the water pump 32, reducing the energy used by the augmentation system. In embodiments where ram pressure alone is used to augment the engine 50, the non restricted water flow reduces the induced drag the system is creating.
The flow of air is not restricted. This increases the efficiency of the jet, which increases available thrust.
Testing has shown that high velocity air will “shatter” the water into droplets. Thus an energy consuming injector is not needed for this process.
Larger droplets of water provide less surface area per mass for heat to be transferred between the hot exhaust and the cool water. This reduces the heat energy losses associated with augmenting the exhaust portion of the turbine.

### Operation of Invention

### Embodiments Portrayed by FIGS. 2-3, 7A-7B, and 9-12

Augmentation is the most beneficial at lower speeds. However, prior systems would not work at all until the vessel speed increased sufficiently for ram pressure to force enough water through injectors. Because the invention incorporates a water pump 32, this issue is eliminated as soon as water is allowed to fill the holding tank 31. FIGS. 2 and 3 show a system where water fills the tank 31 at zero velocity, meaning the augmentation system works during 100% of the acceleration phase. In FIG. 2, the intake system 20 is attached directly to the holding tank 31. A flapper valve 28 keeps water from flowing out of the tank 31 if the system is ever suspended above the water. FIG. 3 incorporates two intake systems 20. One is attached directly to the holding tank 31 without a flapper valve, while the other is ducted to the top of the tank 31 as in the previously discussed embodiment shown by FIG. 1. At low speeds or during operation where the system is never out of the water, only the intake 20 attached directly to the holding tank 31 is open. During operation where the system is regularly removed from the water, only the intake 20 that is ducted to the top of the holding tank 31 is open. The system depicted in FIG. 3 is similar to that of FIG. 2, but is designed without a flapper valve 28, which can be unreliable.

Sea spray intake can reduce the longevity of a turbofan. The problem can be solved simply by moving the engine up a strut or even above the vessel's passenger or cargo compartment. This is accomplished in FIG. 10. By incorporating a water pump 32 in the system this variation is easily accomplished.

While a water pump 32 can be very useful in some applications, it does add to system weight and complexity. It can be removed, as depicted in FIG. 9, by placing the holding tank 31 above the turbine 50. If the tank 31 is simply additional ductwork of larger diameter, system weight and complexity is reduced even more.

In certain applications, not all of the described system components will be needed. For example, in vessels that are designed to keep a portion of the hull below all wave troughs the holding tank 31 and the pump 32 can be removed. This is depicted in FIG. 11. FIG. 12 is similar, except that the bypass air is augmented and not the exhaust portion. This design would work best in long range vessels that spend the vast majority of their life at higher cruise speeds (above 100 knots).

Many vessel designs would permit the water intake 20 to be moved closer towards the bow without significantly reducing the vessel's stability about its vertical axis. The benefit of this design, as pictured in FIG. 13, is that the water does not make many energy-sapping turns as it augments the engine. Fortunately, in many vessel designs the reduction in stability will be extremely negligent and well worth the efficiency of this “in-line” embodiment.

An excellent embodiment of the invention is pictured in FIGS. 7A and 7B. The turbofan 50 is placed high up a strut 42 to avoid sea spray intake, but the bypass air is ducted down towards the water line via an extended jet bypass duct 60. During cruise, the secondary water valve 33 is in position A, allowing the water to augment the bypass air by ram pressure alone. Because the bypass air is ducted down, very little energy is wasted raising the water far above the natural water line. The bypass duct 60 runs the length of the hull 41, which greatly increases the efficiency of the two phase mixture; the long duct provides extra time for the bypass air to accelerate the water to a near simultaneous speed. At slower vessel speeds and during initial acceleration of the vessel, the secondary water valve 33 is in position B. This directs the water to the water pump 32, which then forces the water to augment the bypass air and the jet exhaust. The water pump 32 sits below the water line, so the augmentation can begin during the entire range of acceleration, when augmentation is the most beneficial. Of course as the vessel accelerates to higher speeds valve 33 will move to position A and only the bypass air will be augmented without the aid of a pump.

While FIG. 1 discloses an embodiment of the invention that most simply depicts the various components of the improved water augmentation system, FIG. 7 is the preferred embodiment of the invention. The jet's exposure to sea spray intake is minimal, the bypass duct is elongated to greatly increase the efficiency of the two phase flow, the engine can be augmented during all phases of acceleration, at cruise speeds the water does not need extra energy to raise it to the engine, and no water pump is needed at cruise speeds. In addition, switching from the low speed pump-powered augmentation to the cruise speed, ram-powered, bypass air only augmentation is achieved by moving a single valve 90 degrees. The system is simple, lightweight, extremely efficient, and has a minimal amount of moving parts.

### CONCLUSION AND SCOPE

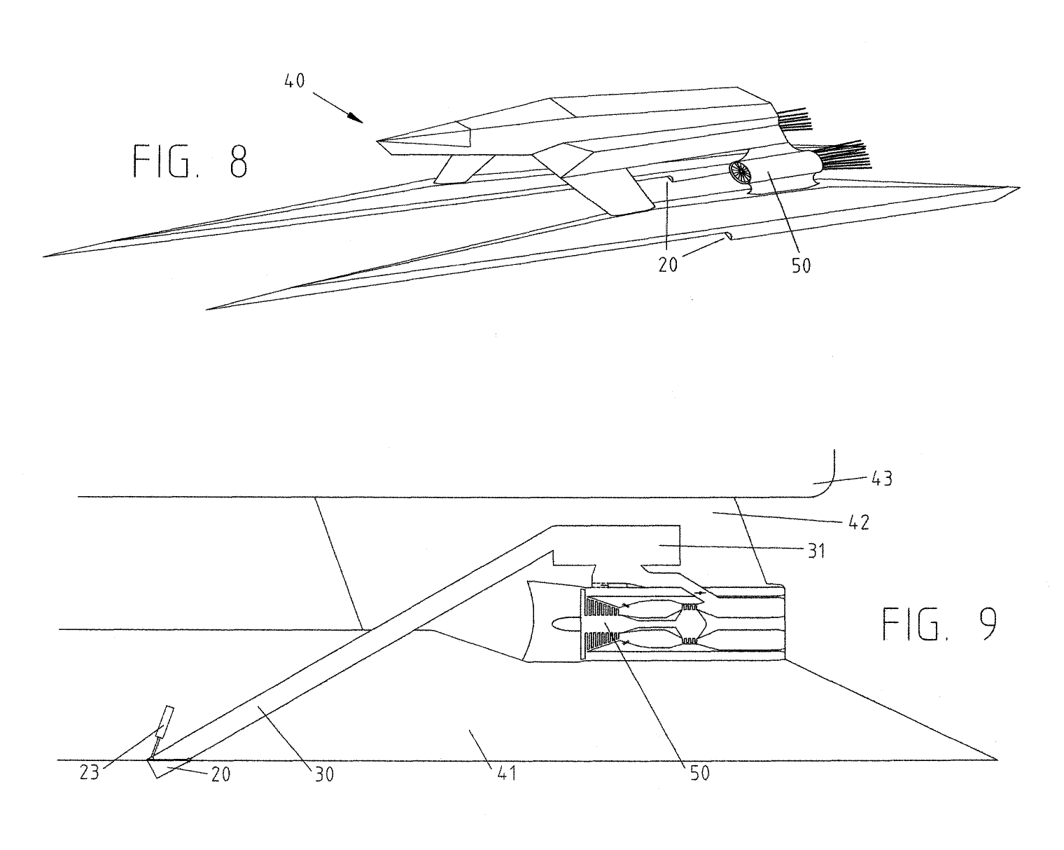

Accordingly, the reader will see that the improved water augmentation system is crucial to achieve a two phase propulsion system that is beneficial at all speeds of operation, provides uninterrupted augmentation, and provides a greater amount of augmentation than previously known. The system is lightweight, simple, and has a minimal amount of moving parts. The additional controls can be computer operated in order to fine tune the amount augmentation at different vessel speeds and engine power settings. The improved system has the ability to create an optimal amount of augmentation under any circumstance. For future high speed vessels such as the H.A.R.T.H. ship depicted by FIG. 8, the improved water-augmented turbofan is the propulsion system of choice.

Of course many variations of the system can be designed beyond what has been previously discussed. For example, the valves controlling the augmentation may be globe or ball valves instead of butterfly and gate valves. Or the intake hydraulic cylinder can be replaced by an electric servo assembly to control the intake scoop. Injectors can also be incorporated, which is also not previously mentioned. Therefore, the scope of this invention should not be limited by the specifics described above, but rather by the claims which follow.

I claim:

1. A water augmentation system comprising a water collection inlet, a duct for distributing water collected by said inlet to a turbine, and a controllable water constricting device whereby the flow rate of said water may be adjusted as desired.

2. The augmentation system of claim 1 wherein said water collection inlet is said water constricting device, specifically a variable water intake system, whereby the amount of water intake and the corresponding drag can be reduced or eliminated at predetermined vessel speeds.

3. The augmentation system of claim 2 wherein said variable water intake system comprises a moveable intake water scoop attached to a vessel hull via a pivot, and a control apparatus for adjusting said moveable intake water scoop.

4. The augmentation system of claim 2 wherein said variable water intake system comprises a fixed intake water scoop, a moveable intake shut-off panel attached to a vessel hull via a pivot, and a control apparatus for adjusting said moveable intake shut-off panel.

5. The augmentation system of claim 1 wherein said water constricting device comprises one or more valves located in said duct whereby the amount of water augmenting said turbine can be controlled.

6. The augmentation system of claim 1 wherein said water constricting device comprises one or more valves located in said duct whereby the flow rate and final destination of the water flowing to different areas of said turbine's gaseous flow can be controlled.

7. The augmentation system of claim 1 where said duct is connected from said water collection inlet to a holding tank positioned above said turbine whereby water can be stored for use and supplied to said turbine when said water collection inlet is suspended above the surface of the water.

8. The augmentation system of claim 1 where said duct is connected from said water collection inlet to the top of a holding tank with a water pump positioned adjacent to said holding tank whereby water can be pressurized and forced through additional ductwork to augment said turbine.

9. The augmentation system of claim 8 where said duct between said water collection inlet and said holding tank is removed, therefore said water collection inlet is attached directly to said water tank, and an automatically closing valve is attached to said water collection inlet inside said water tank, whereby said water tank does not drain during periods when said intake system is suspended above the surface of the water.

10. The augmentation system of claim 8 where an additional variable water intake system opens directly to said water tank positioned below the water line inside the hull of a vessel, whereby water will flood said tank at low vessel speeds, but can be closed to prevent drainage of said tank when said additional intake system is suspended above the surface of the water.

11. The augmentation system of claim 1 wherein said water constricting device comprises a variable water intake system and a secondary valve to selectively guide the water to either a water pump or directly to said turbine.

12. A water augmentation system comprising a duct to direct water to a turbine and a variable water intake system, whereby the amount of water entering the system can be controlled.

13. The augmentation system of claim 12 where said variable water intake system comprises a moveable water intake scoop and a control mechanism for adjusting said moveable intake scoop.

14. The augmentation system of claim 12 where said variable water intake system comprises a fixed water intake scoop, a moveable shut-off panel, and a control mechanism for adjusting said moveable shut-off panel.

15. The water augmentation system of claim 12 wherein a holding tank is utilized for storage of water to augment said turbine during periods that said water intake is suspended above the water.

16. The water augmentation system of claim 15 where a water pump is positioned adjacent to said holding tank, whereby water can be pressurized and forced to augment said turbine.

17. The augmentation system of claim 16 where said variable water intake system is attached directly to said holding tank, and an automatic shut off valve is attached to said variable intake, whereby water will not drain from said holding tank while it is suspended above the surface of the water.

18. The augmentation system of claim 16 where said variable water intake system is positioned ahead of said water tank, and a second variable water intake is attached directly to said holding tank whereby the holding tank will flood at low vessel speeds providing water for augmentation during the acceleration of the vessel.

19. The water augmentation system of claim 12 where said duct directs said water to both the bypass air flow area and the exhaust air flow area of said turbine.

20. The water augmentation system of claim 19 where additional valves are incorporated in said duct, whereby the amount of water augmenting said bypass air flow area and said exhaust air flow area of said turbine can be controlled independently.

21. The water augmentation system of claim 12 where a controllable water-guiding fitting is positioned aft of said intake system which guides water to either a water pump or through said duct to directly augment said turbine.

22. A method of augmenting a turbine engine with water comprising the steps of:
(a) collecting water with a water intake, and
(b) distributing said collected water into said turbine by a duct, and
(c) controlling the amount of water flowing into said turbine with a water constricting fitting,
whereby the amount of augmentation and the resulting drag of the system can be controlled based on vessel speed and engine settings.

23. A method of augmenting a turbine engine with water comprising the steps of:
(a) collecting water with a water collection inlet, and
(b) storing said collected water with a water holding tank, and
(c) distributing said stored water to said turbine by a water duct, and
(d) controlling the amount of water flowing into said turbine with a water constricting device,
whereby the amount of augmentation and the resulting drag of the system can be controlled based on vessel speed and engine settings, and the system will be capable of providing water for augmentation during periods where said water collection inlet is suspended above the surface of the water.

24. A method of augmenting a turbine engine with water comprising the steps of:
(a) collecting water with a water intake, and
(b) distributing said collected water into multiple areas of said turbine via multiple ducts or entryways, and
(c) controlling the amount of water flowing into said turbine and through said multiple ducts or entryways with a plurality of water constricting fittings, possibly including a variable water intake system,
whereby the amount of augmentation to specific areas of said turbine and the overall resulting drag of the system can be controlled based on vessel speed and engine settings.
